(19) United States
(12) Patent Application Publication
(10) Pub. No.: US 2012/0247598 A1
(43) Pub. Date: Oct. 4, 2012

(54) SUBSEA CONNECTION SYSTEM

(76) Inventor: Phil Bremner, Innaloo (AU)

(21) Appl. No.: 13/515,640

(22) PCT Filed: Dec. 14, 2010
(86) PCT No.: PCT/AU10/01685

§ 371 Date: Jun. 13, 2012

(30) Foreign Application Priority Data
Dec. 14, 2009 (AU) 2009906072

(51) Int. Cl. F16L 23/00; F16L 25/00; F16L 19/02; H05B 6/00; F16L 1/12; F16B 35/00; H05B 3/00; B23P 19/00; F16L 55/00

(52) U.S. Cl. 138/106; 29/525.02; 137/372; 137/15.09; 411/378; 411/395; 285/405; 285/420; 29/800

(57) ABSTRACT

A bolt (35) comprising a threaded shaft (36), and a heating element (37) for heating the shaft (36) is disclosed along with a method for securing a first part and a second part of a pipeline system together with the bolt (35). The method includes the steps of: heating the bolt (35) by heating the heating element (37); and securing the heated bolt to the first part and the second part of the pipeline system.

### FIELD OF THE INVENTION

The present invention relates generally to pipeline systems and, in particular, to the connection of parts of pipeline systems.

Although the present invention will be described with particular reference to subsea hydrocarbon pipeline systems, it will be appreciated that the invention is not limited to being used in such pipeline systems and that the invention may, for example, be used in surface pipeline systems or pipeline system that are not hydrocarbon pipeline systems, or even structures or systems other than pipeline systems.

### BACKGROUND ART

Submarine pipeline systems are used in the oil and gas industry to convey hydrocarbons such as oil and natural gas from deep water subsea production trees to a receiving plant for further processing and transmission to onshore plants. The pipeline systems typically include various parts such as flanges, hubs and manifolds that are connected together.

Hydrogen Induced Crack Stressing (HICS) is a problem that can occur when two metal parts, such as for example a metal pipeline and a metal fixed structure hub, of a submarine pipeline system are connected together. The problem usually occurs when the parts are very cold, such as when the parts are located at water depths of 2,000-3,000 metres where the temperature of the water is just above freezing.

HICS occurs when under normal connection and production operation scenarios the flow of hydrocarbons through a pipeline connection raises the temperature of the connected parts very quickly which tests the ability of the metal to retain its physical properties under the stress. The change in the stress/strain properties of a material as a result of the microscopic stress distribution of the material is referred to as the “Bauschinger Effect”.

Another problem with submarine pipeline systems is that the existing connection systems that are used to connect together the parts of such systems are relatively complex and expensive.

Conventional connection systems rely on the use of hydraulic tools to turn a threaded section of bar through a nut in order to close a series of clamps . around the periphery of a flange or coupling arrangement. This turning and torquing of the threaded bar induces very high loads on the areas immediately adjacent to the welded section of the hub and flange arrangement. This straining of the threaded section and the action of bringing two large mating surfaces together have a detrimental affect on the integrity of the steel and of the joint being made.

The following published patent documents disclose other background art that may or may not be relevant to the present invention: U.S. Pat. No. 6,348,674 B1 (RUSSELL); U.S. Pat. No. 6,105,471 A (TAKAYUKI ET AL); U.S. Pat. No. 5,938,964 A (TAKITA ET AL); U.S. Pat. No. 5,397,876 A (SHIMAMOTO ET AL); and U.S. Pat. No. 2,359,046 A (MILLER).

It is against this background that the present invention has been developed.

### SUMMARY OF THE INVENTION

It is an object of the present invention to overcome, or at least ameliorate, one or more of the deficiencies of the prior art mentioned above, or to provide the consumer with a useful or commercial choice.

Other objects and advantages of the present invention will become apparent from the following description, taken in connection with, the accompanying drawings, wherein, by way of illustration and example, a preferred embodiment of the present invention is disclosed.

According to a first broad aspect of the present invention, there is provided a bolt comprising a threaded shaft, and a heating element for heating the shaft.

Preferably, the shaft includes a cavity, and the heating element is inserted into the cavity such that the shaft is able to be heated by the heating element. In a particular preferred form, the cavity and the heating element extend substantially along the full length of the shaft.

Preferably, the heating element is an electrical heating element. In one particular preferred embodiment, the heating element is an electrical heating coil. In an alternative particular preferred embodiment, the heating element is an electrical heating rod.

Preferably, the bolt includes a head from which the threaded shaft extends.

According to a second broad aspect of the present invention, there is provided a method for securing a first part and a second part of a pipeline system together with the bolt according to the first broad aspect of the present invention, the method comprising the steps of:

heating the bolt by heating the heating element of the bolt; and

securing the heated bolt to the first part and the second part:

Preferably, the shaft is heated to an optimum temperature. In a preferred form, the optimum temperature is the temperature required to expand the bolt to its elastic limit.

Preferably, the securing step includes tightening a nut that is screwed on to the shaft of the bolt. It is preferred that the nut is tightened until the bolt has been heated to the optimum temperature. Preferably, the step of heating the bolt is discontinued once the bolt has been heated to the optimum temperature.

According to a third broad aspect of the present invention, there is provided a connection assembly for securing a first part of a pipeline system to a second part of the system, the assembly comprising a first portion, a second portion, and a bolt according to the first broad aspect of the present invention extending between the first portion and the second portion.

The connection assembly may be used for example to secure a pipe relative to an end flange, or to connect a first pipe to a second pipe. In a first preferred embodiment of the connection assembly that may be used for either of these purposes, the first portion includes a first flange, the second portion includes a second flange, and the bolt extends between the first flange and the second flange. In a second preferred embodiment of the connection assembly that may be used for this purpose, the first portion includes a first jaw for clamping on to the first part and the second part, the, second portion includes a second jaw for clamping on to the first part and the second part, wherein the second jaw is hinged relative to the first jaw, and the bolt extends between the first jaw and the second jaw.

Alternatively, the connection assembly may be used for example to secure a valve bonnet to a valve body. In a preferred embodiment of the connection assembly that may be used for this purpose, the first portion includes a rim surrounding an opening in a valve body, the second portion includes a flange of a valve bonnet for covering the opening, and the bolt extends between the flange and the rim.

According to a fourth broad aspect of the present invention, there is provided a method for securing a first part of a pipeline system to a second part of the system using the connection assembly according to the, third broad aspect of the present invention, the method comprising the steps of:

heating the bolt of the connection assembly by heating the heating element of each bolt; and

securing the first part to the second part with the connection assembly while each bolt of the connection assembly is heated.

Preferably, the heating step includes connecting the heating element of the bolt to a source of electricity so that an electrical current is able to flow through the element and heat the element.

In one preferred embodiment, the securing step includes tightening a nut that is screwed on to the shaft of the bolt. In another preferred embodiment, the securing step includes rotating the bolt relative to the first portion and the second portion of the connection assembly.

According to a fifth broad aspect of the present invention, there is provided a clamp for securing a first part of a pipeline system to a second part of the system, the clamp comprising a first jaw, a second jaw hinged relative to the first jaw, and a bolt according to the first broad aspect of the present invention extending between the first jaw and the second jaw.

According to a sixth broad aspect of the present invention, there is provided a connector for securing an end flange to a pipe, the connector comprising a first flange for the pipe, a second flange for the end flange, and a bolt according to the first broad aspect of the present invention extending between the first flange and the second flange.

According to a seventh broad aspect of the present invention, there is provided a connector for securing a first pipe to a second pipe, the connector comprising a first flange for the first pipe, a second flange for the second pipe, and a bolt according to the first broad aspect of the present invention extending between the first flange and the second flange.

According to an eighth broad aspect of the present invention, there is provided a valve comprising a valve body including a rim surrounding an opening in the body, a valve bonnet for covering the opening, the valve bonnet including a flange, and a bolt according to the first broad aspect of the present invention extending between the flange and the rim.

According to a ninth broad aspect of the present invention, there is provided a pipeline system comprising a first part, a second part, and a connection assembly securing the first part to the second part, the connection assembly comprising a bolt according to the first broad aspect of the present invention.

Preferably, the connection assembly is able to be heated by heating the heating element of the bolt.

Preferably, the pipeline system is a hydrocarbon pipeline system. For example, the pipeline system may be an oil or gas pipeline system.

In a preferred form, the pipeline system is a pipeline system for a cold environment. In a particular preferred form, the pipeline system is a subsea pipeline system.

Preferably, the pipeline system also includes a thermal insulator for retaining heat in the connection assembly, the first part, and the second part. In a preferred form, the thermal insulator is a blanket.

According to a tenth broad aspect of the present invention, there is provided a method for heating the connection assembly of the pipeline system according to the ninth broad aspect of the present invention, the method comprising the steps of:

heating the connection assembly by heating the heating element of the bolt of the assembly; and

allowing heated matter to flow through the pipeline system such that heat from the heated matter is able to be transferred to the heated connection assembly.

Preferably, the heating step includes connecting the heating element of the bolt to a source of electricity so that an electrical current is able to flow through the element and heat the element. Preferably, the method also includes the step of disconnecting the source of electricity from the bolt after the allowing step.

Preferably, the allowing step includes allowing the heated matter to flow through the first part and the second part of the pipeline system.

According to an eleventh broad aspect of the present invention, there is provided a connection apparatus for securing a first part of a pipeline system to a second part of the system, the apparatus comprising a bolt according to the first broad aspect of the present invention, a nut for screwing on to the threaded shaft of the bolt, and a drive for rotating the nut on the threaded shaft.

Preferably, the drive is an electrical drive. It is preferred that the drive includes a coil that, when energised, is able to cause the drive to rotate the nut on the threaded shaft. In a preferred form, the coil is a toroidal coil.

Preferably, the drive includes a dog for engaging with the nut so that the drive is able to rotate the nut on the threaded shaft.

Preferably, the apparatus also includes another nut for screwing on to the threaded shaft, and a pair of cams located between the nuts. It is preferred that each cam is a washer that includes a plurality of teeth, and that at least some of the teeth of each washer are engageable with each other.

According to a twelfth broad aspect of the present invention, there is provided a method for securing a first part of a pipeline system to a second part of the system with the connection apparatus according to the eleventh broad aspect of the present invention, the method comprising the steps of:

inserting the bolt of the connection apparatus through the first part and the second part of the pipeline system;

heating the bolt by heating the heating element of the bolt; and

tightening a nut that is screwed on to the bolt.

Preferably, the bolt is heated to an optimum temperature. In a preferred form, the optimum temperature is the temperature required to expand the bolt to its elastic limit.

Preferably, the step of tightening the nut is discontinued once the bolt has been heated to the optimum temperature.

Preferably, the step of heating the bolt is discontinued once the bolt has been heated to the optimum temperature.

### BRIEF DESCRIPTION OF THE DRAWINGS

In order that the invention may be more fully understood and put into practice, a preferred embodiment thereof will now be described with reference to the accompanying drawings, in which:

FIG. 1 is a cross-sectional side elevation of a connection assembly;

FIG. 2 is a perspective view of part of the shaft and the heating element of a bolt of the connection assembly;

FIG. 3 is a plan view of the heating element of the connection assembly;

FIG. 4 is a side elevation of a first clamp;

FIG. 5 is a side elevation of a second clamp;

FIG. 6 is a side elevation of a third clamp;

FIG. 7 is a side elevation of a first connector for connecting a pipe to an end flange;

FIG. 8 is a side elevation of a second connector for connecting a pipe to an end flange;

FIG. 9 is a side elevation of a first connector for connecting a first pipe to a second pipe;

FIG. 10 is a side elevation of a second connector for connecting a first pipe to a second pipe; and

FIG. 11 is a side elevation of a top entry ball valve;

FIG. 12 is a side elevation of a first connection apparatus;

FIG. 13 is a side elevation of a portion of the first connection apparatus;

FIG. 14 is a perspective view of a second connection apparatus prior to heating the bolt of the apparatus and tightening the nuts of the apparatus; and

FIG. 15 is a perspective view of the second connection apparatus after heating the bolt of the apparatus and tightening the nuts of the apparatus.

### BEST MODE(S) FOR CARRYING OUT THE INVENTION

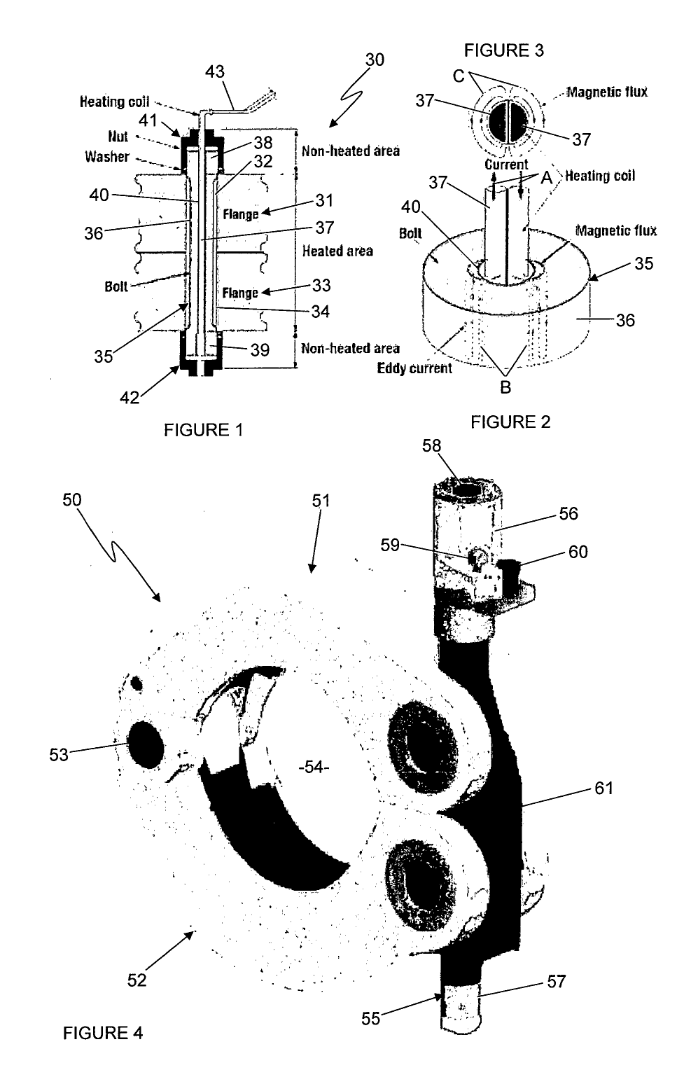

A connection assembly 30 for securing a first part of a subsea hydrocarbon pipeline system to a second part of the system is depicted in FIG. 1. The hydrocarbon pipeline system may, for example, be for transporting oil or natural gas from deep water subsea production trees to a receiving plant for further processing and transmission to onshore plants. The pipeline system may include any number of components, including pipes, flanges, hubs and manifolds.

The connection assembly 30 may be used to secure various parts of the pipeline system to each other. For example, the assembly may be used to secure a first pipe of the pipeline system to a second pipe of the system, or it may be used to connect an end flange of the pipeline system to a pipe of the system.

Assembly 30 includes a first portion that includes a first flange 31 having an opening 32, and a second portion that includes a second flange 33 having an opening 34. Opening 32 extends all the way through flange 31, and opening 34 extends all the way through flange 33. The first portion is typically secured relative to the first part of the pipeline system, and the second portion is typically secured relative to the second part of the pipeline system.

A hollow bolt 35 extends through the opening 32 in the first flange 31 and the opening 34 in the second flange 33. Bolt 35 includes a threaded shaft 36 and an electrical heating element in the form of an electrical heating coil 37 for heating the shaft 36. Shaft 36 includes a first threaded end portion 38, a second threaded end portion 39, and a cavity 40 extending the length of the shaft 36. Coil 37 is inserted into the cavity 40 so that the coil 37 is able to heat the shaft 36.

A first nut 41 is screwed on to the first threaded end portion 38 of the shaft 36, and a second nut 42 is screwed on to the second threaded end portion 39.

Before the first nut 41 and the second nut 42 are tightened, a source of electricity (not depicted) is connected to the coil 37 by an electrical conductor 43 so that an electrical current flows through and heats the coil 37, which in turn heats the bolt 35 comprising the shaft 36. The bolt 35 is heated in this way so that it expands to its elastic limit within the connection assembly 30. Once the bolt 35 has expanded to its elastic limit, nuts 41 and 42 are tightened until they are locked against the flanges 31, 33 and are thereby stopped from being rotated further relative to the bolt 35 in a tightening direction. The electrical current that is supplied to the coil 37 is then removed or reduced.

Arrows ‘A’ in FIG. 2 depict the direction of electrical current flow through the heating coil 37 when the source of electricity is connected to the coil 37. The current flow in the coil 37 induces electrical eddy currents in the bolt 35. The direction of the eddy current flow in the bolt 35 is depicted in FIG. 2 by arrows ‘B’. The current flow in the coil 37 produces a magnetic field that surrounds the coil 37. Lines of magnetic flux of the magnetic field that is produced by the current flow in the coil 37 are depicted in FIG. 3 by arrows ‘C’.

Heating the bolt 35 prior to tightening the nuts 41, 42 reduces the stress that the metal of the connection assembly 30 is subjected to, and makes the assembly 30 and the parts that it connects together less likely to experience HICS.

Heat from the bolt 35 is able to be transferred to other parts of the connection assembly 30 as well as to the parts of the hydrocarbon pipeline system that are secured to each other by the assembly 30. The electrical current supplied to the coil 37 may be reduced after the nuts 41, 42 are tightened so that sufficient current flows through the coil 37 to maintain the connection assembly 30 at a temperature which is elevated relative to the ambient temperature of the subsea environment in which the pipeline system resides. The temperature of the connection assembly 30 can be maintained in this manner until hydrocarbons that are also at an elevated temperature relative to that of the subsea environment start flowing through the connection which includes the connection assembly 30. Heat from the hydrocarbons flowing through the connection is able to maintain the connection at a temperature which is elevated relative to the ambient temperature. Maintaining the assembly 30 at temperature which is elevated relative to the ambient temperature up until the hydrocarbons start flowing through the connection prevents sudden thermal contraction of the various components of the assembly 30, including the bolt 35, which can damage the connection.

The insertion of the bolt 35 into the openings 32, 34 of the flanges 31, 33, screwing of the nuts 41, 42 on to the shaft end portions 38, 39, connection/disconnection of the coil 37 to a source of electricity, and controlling of the source of electricity, when carried-out in a subsea environment, will typically be done with the aid of a Work Class Remotely Operated Vehicle or ROV (not depicted) which would typically use a manipulator arm to perform at least some of the operations. The operation of applying electrical power to the coil 37 would typically be monitored through a multiplexer that is part of the electronics of the ROV. The process would typically be continually monitored and assessed by onboard diagnostics with the ROV electronics, and by means of heat-seeking cameras which would capture thermal images of the bolt 35 which would be relayed to a control room where they would be displayed in the form of thermal-imaging model graphics.

A connection assembly in the form of a first clamp 50 for securing a first part of a subsea hydrocarbon pipeline system to a second part of the system is depicted in FIG. 4. Clamp 50 may be used to secure various parts of the pipeline system to each other. For example, the clamp 50 may be used to secure a first pipe of the pipeline system to a second pipe of the system, or it may be used to connect an end flange of the pipeline system to a pipe of the system.

Clamp 50 includes a first portion that includes a first jaw 51, a second portion that includes a second jaw 52, and a pivot 53 that hinges the first jaw 51 to the second jaw 52. The first jaw 51 and the second jaw 52 define a generally circular opening 54 for receiving the first and second parts of the system that are to be secured together with the clamp 50.

A bolt 55 extends between the first and second jaws 51, 52 and is received by a bolt receptacle 61. Bolt 55 is coupled to the first and second jaws 51, 52 such that it is able to be rotated about its longitudinal axis relative to the jaws 51, 52. Moreover, it is coupled to the jaws 51, 52 such that rotation of the bolt 55 in one direction causes the jaws 51, 52 to open, and such that rotation of the bolt 55 in the opposite direction causes the jaws 51, 52 to close. When the jaws 51, 52 are opened by rotating the bolt 55, the jaws 51, 52 pivot away from each other so that the opening 54 enlarges. Enlarging the opening 54 by a sufficient amount allows the first and second parts of the pipeline to be removed from or inserted into the opening 54. When the jaws 51, 52 are closed by rotating the bolt 55, the jaws 51, 52 pivot towards each other so that the opening 54 is reduced in size. Pivoting the jaws 51, 52 towards each other by a sufficient amount when the first part and the second part of the pipeline are inserted into the opening 54 will result in the jaws 51, 52 clamping on to the first and second parts so that the parts are thereby secured to each other.

Bolt 55 includes a hexagonal head 56, a threaded shaft 57 extending from the head 56, and an electrical heating element (not depicted) for heating the shaft 57. A cavity 58 extends through the head 56 and at least partially through the length of the shaft 57. The heating element is inserted into the cavity 58 so that the element is able to heat the shaft 57. Heat produced by the heating element is able to be transferred from the shaft 57 to the other parts of the clamp 50, including the jaws 51, 52. When the first and second parts of the pipeline are secured together by the clamp 50, heat is able to be transferred from the clamp 50 to the first and second parts. Bolt 55 also includes a first terminal 59 and a second terminal 60 for connecting a source of electricity (not depicted) to the heating element so that an electrical current is able to flow from the source of electricity and through the heating element.

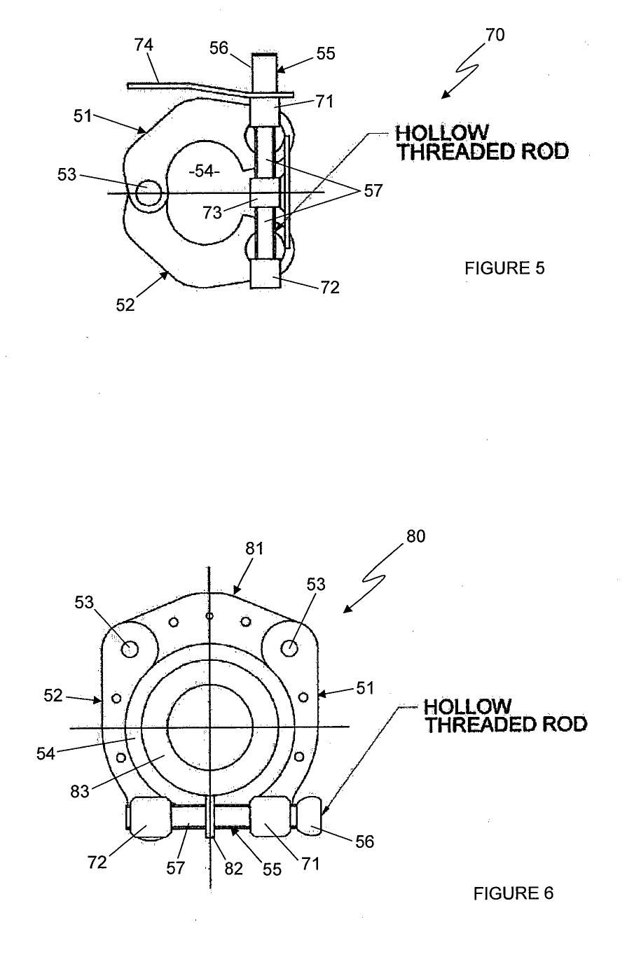

A connection assembly in the form of a second clamp 70 for securing a first part of a subsea hydrocarbon pipeline system to a second part of the system is depicted in FIG. 5. Clamp 70 is particularly suitable for connecting a MEG pipeline to an XT hub.

Clamp 70 is similar to the clamp 50, and like reference numbers have therefore been used to reference like features of the two clamps 50, 70.

Clamp 70 also includes a first internally threaded sleeve 71 secured relative to the first jaw 51, and a second internally threaded sleeve 72 secured relative to the second jaw 52. The threaded shaft 57 of the bolt 55 is screwed into the sleeves 71, 72. Moreover, clamp 70 has a sleeve 73 through which the shaft 57 extends. Sleeve 73 is secured relative to the jaws 51, 52 such that rotation of the bolt 55 relative to the sleeves 71, 72, 73 causes the jaws 51, 52 to pivot relative to each other. A lever 74 for rotating the bolt 55 is secured to and extends from the bolt head 56.

The bolt 55 of the clamp 70 also includes an electrical heating element (not depicted) that is received by a cavity (not depicted) in the hollow shaft 57 of the bolt 55. The heating element is able to be connected to a source of electricity (not depicted) so that an electrical current is able to flow from the source and through the element to thereby heat the element.

A connection assembly in the form of a third clamp 80 for securing a first part of a subsea hydrocarbon pipeline system to a second part of the system is depicted in FIG. 6. Clamp 80 is particularly suitable for connecting an XT hub to a flexible or rigid production pipeline.

Clamp 80 is similar to the clamp 70, and like reference numbers have therefore been used to reference like features of the two clamps 70, 80.

Clamp 80 also includes a cross-member 81 to which the jaws 51, 52 are hinged by pivots 53 so that the jaws 51, 52 are able to be pivoted relative to the cross-member 81 and to each other. A flange 82 extends from the threaded shaft 57 of the clamp 80.

The bolt 55 of the clamp 80 also includes an electrical heating element (not depicted) that is received by a cavity (not depicted) in the hollow shaft 57 of the bolt 55. The heating element is able to be connected to a source of electricity (not depicted) so that electrical current is able to flow from the source and through the element to thereby heat the element.

A pipe 83 is shown located in the opening 54 of the clamp 80 when the jaws 51, 52 have been opened so that they are not clamped on to the pipe 83.

Before the first and second parts of the pipeline system are clamped between the jaws 51, 52 of the clamp 50, 70, or 80 by rotating the bolt 55 relative to the jaws 51, 52 in the appropriate direction, the source of electricity is connected to the heating element of the bolt 55 so that an electrical current is able to flow from the source and through the heating element so that the element is heated. Heat from the heating element is transferred to the bolt 55 so that it expands to its elastic limit. Once the bolt 55 has expanded to its elastic limit, the bolt 55 is rotated relative to the jaws 51, 52 until they are firmly clamped against the first and second parts. The electrical current that is supplied to the heating element is then removed or reduced.

Clamp 50, 70, 80 can be pre-heated by the heating element in the bolt 55 prior to allowing hydrocarbons to flow through the parts of a pipeline system that are connected together by the clamp 50, 70, 80. Pre-heating the clamp 50, 70, 80 prevents it from being subjected to a sudden thermal contraction that may damage it.

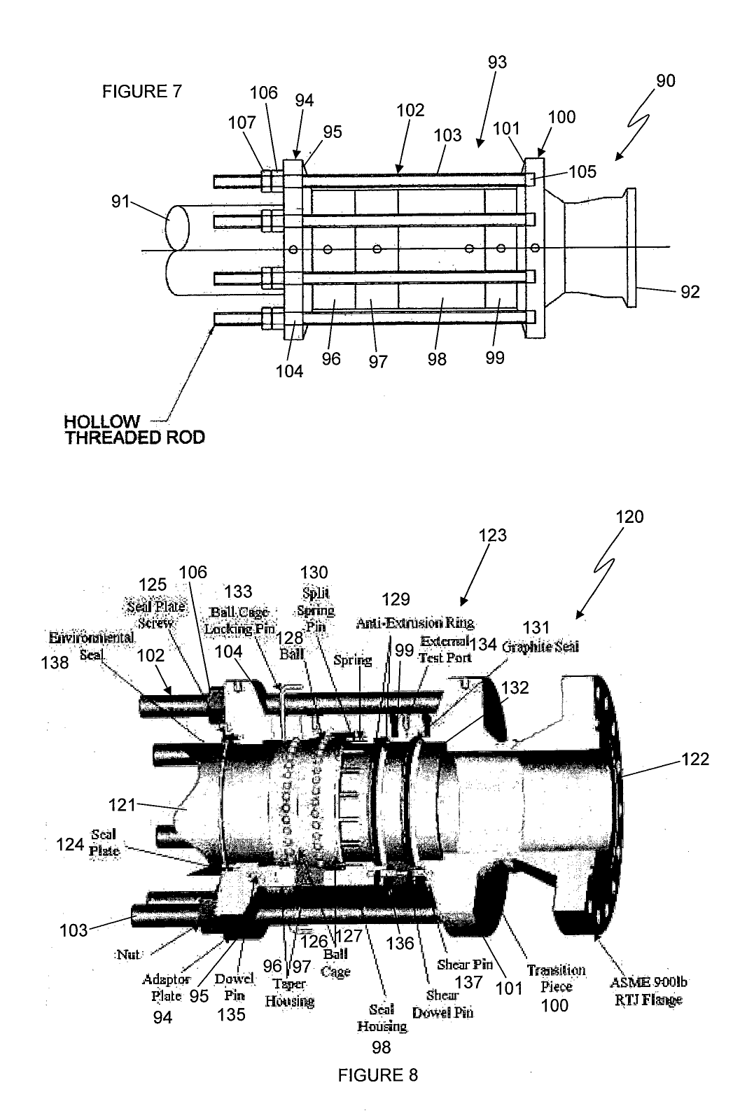

FIG. 7 depicts part of a subsea hydrocarbon pipeline system 90 that includes a pipe 91, an end flange 92, and a connection assembly in the form of a connector 93 that secures the pipe 91 and the end flange 92 together. The pipe 91, connector 93 and the end flange 92 are part of a single end CRA lined repair.

Connector 93 includes a first portion 94 having a first flange 95 that extends around the circumference of the pipe 91 and that is secured relative to the pipe 91. An end portion of the pipe 91 extends through a first housing 96, a second housing 97, a third housing 98, and a fourth housing 99. Connector 93 also includes a second portion 100 having a second flange 101 that extends around the circumference of the pipe 91 and that is secured relative to the end flange 92.

A plurality of circumferentially-spaced hollow bolts 102 extend between the first flange 95 and the second flange 101. Each bolt 102 includes an externally threaded shaft 103. The shaft 103 of each bolt 102 extends through a respective opening 104 in the first flange 95, and an end of the shaft 103 is received by a respective blind opening 105 in the second flange 101 such that the end of the shaft 103 is secured to the flange 101. For example, each blind opening 105 may include an internal thread, and the externally-threaded shafts 103 may be screwed into the openings 105 such that the shafts 103 are secured to the flange 101. A respective nut 106 is screwed on to the opposite end of each shaft 103. A respective locking nut 107 is also screwed on to each shaft 103 to prevent inadvertent loosening of the nuts 106.

Each bolt 102 also includes an electrical heating element (not depicted) for heating the shaft 103. A cavity (not depicted) extends at least partially through the length of the shaft 103. The heating element is inserted into the cavity so that the element is able to heat the shaft 103. Heat produced by the heating element is able to be transferred from the shaft 103 to the other parts of the connector 93; including the first portion 94 and the second portion 100. Heat is also able to be transferred from the connector 93 to the pipe 91 and the end flange 92.

FIG. 8 depicts part of a subsea hydrocarbon pipeline system 120 that includes a pipe 121, an end flange 122, and a connection assembly in the form of a connector 123 that secures the pipe 121 and the end flange 122 together.

Connector 123 is similar to the connector 93, and like reference numbers have therefore been used to reference like features of the two connectors 93, 123.

Connector 123 includes a first portion that is in the form of a hollow adaptor plate 94 that is secured relative to the pipe 121. Plate 94 has a first flange 95 that extends around the circumference of the pipe 121. A seal plate 124 extends around the circumference of the pipe 121 and is secured to the adaptor plate 94 by a plurality of screws 125.

A first cylindrical ball cage 126 and a second cylindrical ball cage 127 extend around the circumference of the pipe 121. Each ball cage 126, 127 supports a plurality of circumferentially-spaced balls/ball bearings 128.

Two pairs of adjacent anti-extrusion rings 129 extend around the circumference of the pipe 121, and a plurality of circumferentially-spaced split spring pins 130 extend between the ball cage 127 and one of the anti-extrusion rings 129. A respective graphite seal 131 is located between each pair of rings 129, and extends around the circumference of the pipe 121.

Connector 123 also includes a second portion that is in the form of a hollow transition piece 100. Transition piece 100 includes a recessed edge 132 that receives an end of the pipe 121, and a circumferentially-extending second flange 101. Transition piece 100 is connected to the end flange 122 which is an ASME 900 lb RTJ flange.

A first taper housing 96 and a second taper housing 97 extend around the circumference of the pipe 121 and are located adjacent to the ball cages 126, 127. A plurality of ball cage locking pins 133 extend through openings in the first taper housing 96 and into the first ball cage 126.

A first seal housing 98 and a second seal housing 99 extend around the circumference of the pipe 121. Housing 99 includes an external test port 134.

A dowel pin 135 extends between the adaptor plate 94 and the first taper housing 96, and is received by a blind opening in the plate 94 and a blind opening in the housing 96.

A shear pin 136 extends between the first seal housing 98 and the second seal housing 99, and is received by a blind opening in the housing 98 and a blind opening in the housing 99.

A shear pin 137 extends between the second seal housing 99 and the transition piece 100, and is received by a blind opening in the housing 99 and a blind opening in the transition piece 100.

An environmental seal 138 is positioned between the seal plate 124 and the adaptor plate 94.

A plurality of circumferentially-spaced hollow bolts 102 extend between the first flange 95 and the second flange 101. Each bolt 102 includes a threaded shaft 103. The shaft of each bolt 102 extends through a respective opening 104 in the first flange 95, and an end of the shaft 103 is secured to the flange 101. A respective nut 106 is screwed on to the opposite end of each shaft 103.

Each bolt 102 also includes an electrical heating element (not depicted) for heating the shaft 103. A cavity (not depicted) extends at least partially through the length of the shaft 103. The heating element is inserted into the cavity so that the element is able to heat the shaft 103. Heat produced by the heating element is able to be transferred from the shaft 103 to the other parts of the connector 123, including the adaptor plate 94 and the transition piece 100. Heat is also able to be transferred from the connector 123 to the pipe 121 and the end flange 122.

Before the pipes 91, 121 and the end flanges 92, 122 of the pipeline systems 90, 120 are secured together by tightening the nuts 106, 107 of the connectors 93, 123, a source of electricity is connected to the heating element of each bolt 102 so that an electrical current is able to flow from the source and through the heating element so that the element is heated. Heat from the heating elements is transferred to the bolts 102 so that they each expand to their elastic limit. Once the bolts 102 have expanded to their elastic limit, the nuts 106, 107 are rotated relative to the bolts 102 until the pipes 91, 121 and the end flanges 92, 122 are firmly secured together. The electrical current that is supplied to the heating element is then removed or reduced.

Connectors 93, 123 can be pre-heated by the heating element of each bolt 102 prior to allowing hydrocarbons to flow through the pipes 91, 121 and the end flanges 92, 122 of the pipeline systems 90, 120. Pre-heating the connectors 93 and 123 prevents them from being subjected to a sudden thermal contraction that may damage them.

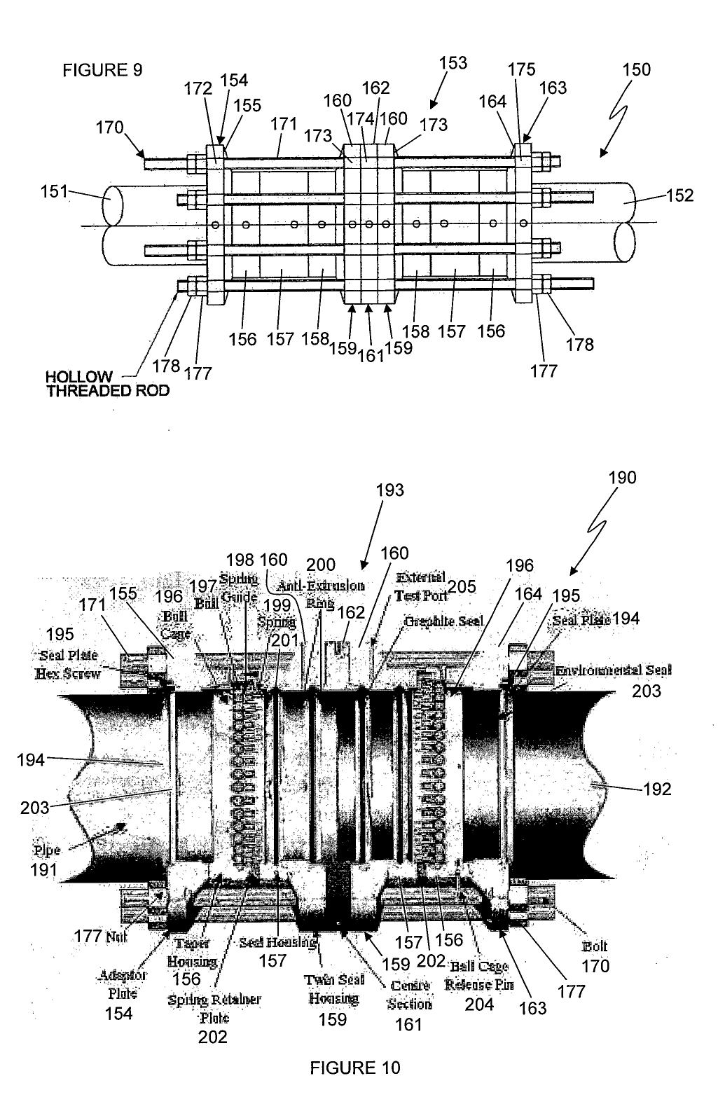

FIG. 9 depicts part of a subsea hydrocarbon pipeline system 150 that includes a first pipe 151, a second pipe 152, and a connection assembly in the form of a connector 153 that secures the first pipe 151 and the second pipe 152 together. The first pipe 151, second pipe 152 and the connector 153 are part of a dual end pipeline repair.

Connector 153 includes a first portion 154 having a first flange 155 that extends around the circumference of the first pipe 151 and that is secured relative to the pipe 151. Connector 153 includes a second portion 163 having a second flange 164 that extends around the circumference of the second pipe 152 and that is secured relative to the pipe 152.

A respective first housing 156, second housing 157, third housing 158, and fourth housing 159 extend around the circumference of each pipe 151, 152. Each housing 159 includes a flange 160.

An end portion of the first pipe 151 and an end portion of the second pipe 152 are received by a centre section 161 that includes a flange 162.

A plurality of circumferentially-spaced hollow bolts 170 extend between the first flange 155 and the second flange 164. Each bolt 170 includes an externally threaded shaft 171. The shaft 171 of each bolt 170 extends through a respective opening 172 in the first flange 155, a respective opening 173 in each flange 160, a respective opening 174 in the flange 162, and a respective opening 175 in the second flange 164.

A respective nut 177 is screwed on to each end of each shaft 170. A respective locking nut 178 is also screwed on to each end of each shaft 170 to prevent inadvertent loosening of the nuts 177.

Each bolt 170 also includes an electrical heating element (not depicted) for heating the shaft 171. A cavity (not depicted) extends at least partially through the length of the shaft 171. The heating element is inserted into the cavity so that the element is able to heat the shaft 171. Heat produced by the heating element is able to be transferred from the shaft 171 to the other parts of the connector 123 including the first portion 154, second portion 163, housings 159, and the centre section 161. Heat is also able to be transferred from the connector 153 to the pipes 151 and 152.

FIG. 10 depicts part of a subsea hydrocarbon pipeline system 190 that includes a first pipe 191, a second pipe 192, and a connection assembly in the form of a connector 193 that secures the first pipe 191 and the second pipe 192 together.

Connector 193 is similar to the connector 153, and like reference numbers have therefore been used to reference like features of the two connectors 153, 193.

Connector 193 includes a first portion that is in the form of a hollow adaptor plate 154 that is secured relative to the first pipe 191. Plate 154 has a first flange 155 that extends around the circumference of the pipe 191. Connector 193 includes a second portion that is in the form of a hollow adaptor plate 163 that is secured relative to the second pipe 192. Plate 163 has a second flange 164 that extends around the circumference of the pipe 192. A respective seal plate 194 extends around the circumference of the pipe 191 and the pipe 192. The seal plates 194 are secured to the adaptor plates 154, 163 by a plurality of screws 195.

A respective cylindrical ball cage 196 extends around the circumference of the pipe 191 and the pipe 192. Each ball cage 196 has a plurality of circumferentially-spaced balls 197, a plurality of circumferentially-spaced spring guides 198, and a respective spring 199 for each guide 198.

Each pipe 191, 192 has two pairs of adjacent anti-extrusion rings 200 extending around its circumference. A respective graphite seal 201 is located between each pair of rings 200. The graphite seals 201 extend around the circumference of the pipe 191.

A respective first taper housing 156, spring retainer plate 202, seal housing 157, and seal housing 159 extend around the circumference of each pipe 191, 192. Each housing 159 includes a flange 160.

An end portion of the first pipe 191 and an end portion of the second pipe 192 are received by a centre section 161 that includes a flange 162.

A respective environmental seal 203 is located between each seal plate 194 and the adaptor plates 154, 163.

A plurality of ball cage release pins 204 extend through openings in each first taper housing 156 and each ball cage 196.

Each housing 156 includes an external test port 205.

A plurality of circumferentially-spaced hollow bolts 170 extend between the first flange 155 and the second flange 164. Each bolt 170 includes an externally threaded shaft 171. The shaft 171 of each bolt 170 extends through a respective opening in the first flange 155, a respective opening in each flange 160, a respective opening in the flange 162, and a respective opening in the second flange 164.

A respective nut 177 is screwed on to each end of each shaft 170.

Each bolt 170 also includes an electrical heating element (not depicted) for heating the shaft 171. A cavity (not depicted) extends at least partially through the length of the shaft 171. The heating element is inserted into the cavity so that the element is able to heat the shaft 171. Heat produced by the heating element is able to be transferred from the shaft 171 to the other parts of the connector 193 including the adaptor plates 154, 163, housings 159, and the centre section 161. Heat is also able to be transferred from the connector 193 to the pipes 191 and 192.

Before the first pipe 151, 191 and the second pipe 152, 192 of the pipeline systems 150, 190 are secured together by tightening the nuts 177, 178 of the connectors 153, 193, a source of electricity is connected to the heating element of each bolt 170 so that an electrical current is able to flow from the source and through the heating element so that the element is heated. Heat from the heating elements is transferred to the bolts 170 so that they each expand to their elastic limit. Once the bolts 170 have expanded to their elastic limit, the nuts 177, 178 are rotated relative to the bolts 170 until the first pipe 151, 191 and the second pipe 152, 192 are firmly secured together. The electrical current that is supplied to the heating element is then removed or reduced.

Connectors 153, 193 can be pre-heated by the heating element of each bolt 170 prior to allowing hydrocarbons to flow through the first pipe 151, 191 and the second pipe 152, 192 of the pipeline systems 150, 190. Pre-heating the connectors 153 and 193 prevents them from being subjected to a sudden thermal contraction that may damage them.

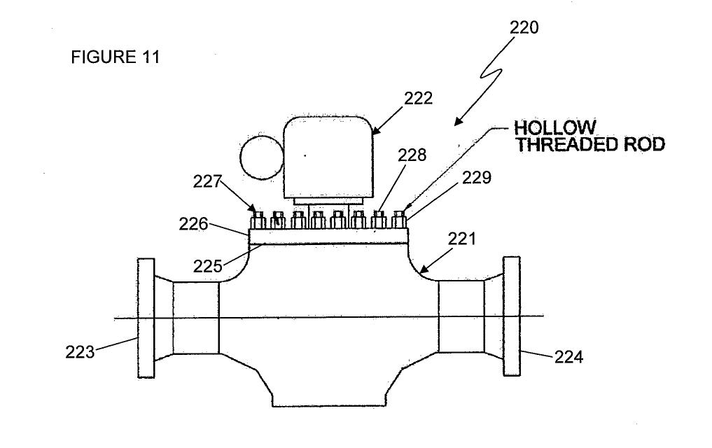

Referring to FIG. 11, a recoverable top entry ball valve 220 for a subsea hydrocarbon pipeline system includes a valve body 221 and a valve bonnet 222. Valve body 221 includes an outlet 223, an inlet 224, and a rim 225 surrounding an opening (not depicted) in the top of the body 221. Valve bonnet 222 includes a flange 226.

Valve 220 also includes a plurality of hollow bolts 227. Each bolt 227 includes an externally threaded shaft 228. The shaft 228 of each bolt 227 is secured to the valve body 221 and extends upwardly from the rim 225 of the body 221 through a respective opening in the flange 226. A respective nut 229 is screwed on to the end of each shaft 228.

Each bolt 227 also includes an electrical heating element (not depicted) for heating the shaft 228. A cavity (not depicted) extends at least partially through the length of the shaft 228. The heating element is inserted into the cavity so that the element is able to heat the shaft 228. Heat produced by the heating element is able to be transferred from the shaft 228 to the other parts of the valve 220 including the valve body 221 and the valve bonnet 222.

Before the valve body 221 and the valve bonnet 222 of the valve 220 are nut 244 on the threaded shaft 242. Drive 249 includes a plurality of driving dogs 250 that engage with recesses 251 in the nut 244 so that the drive 249 is able to rotate the nut 244 on the threaded shaft 242. Drive 249 also includes a large toroidal coil 252 that, when energised by passing an electrical current through it, is able to cause the drive 249 to rotate the nut 244 on the threaded shaft 242.

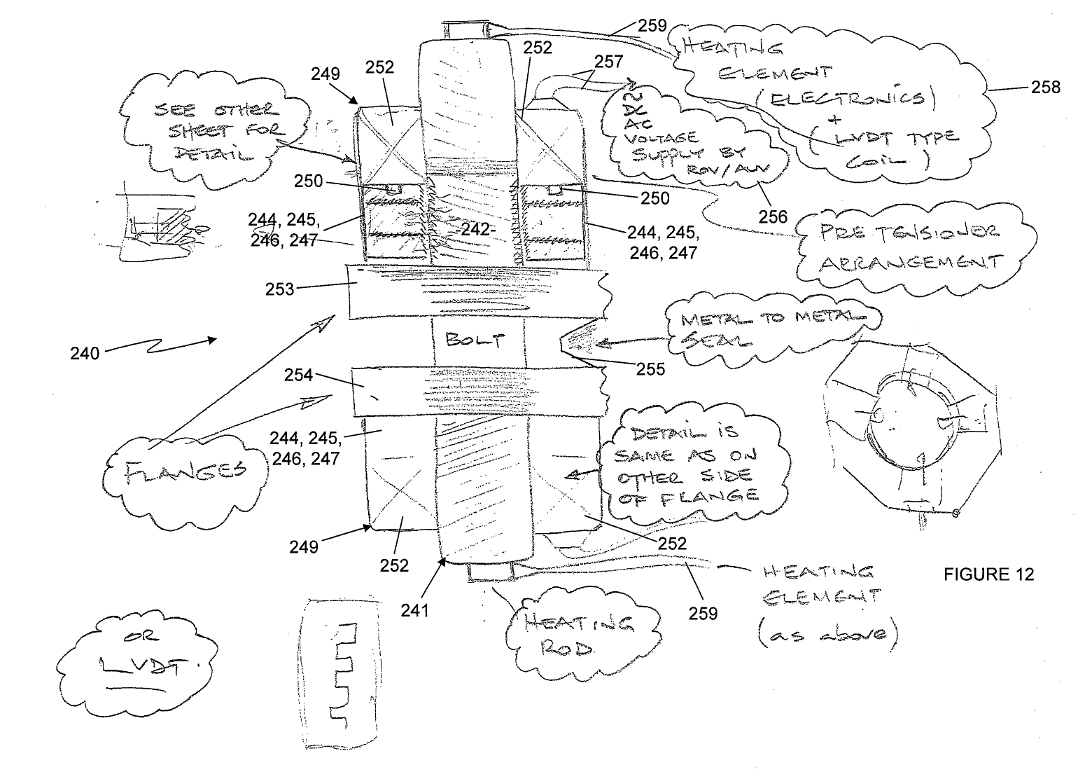

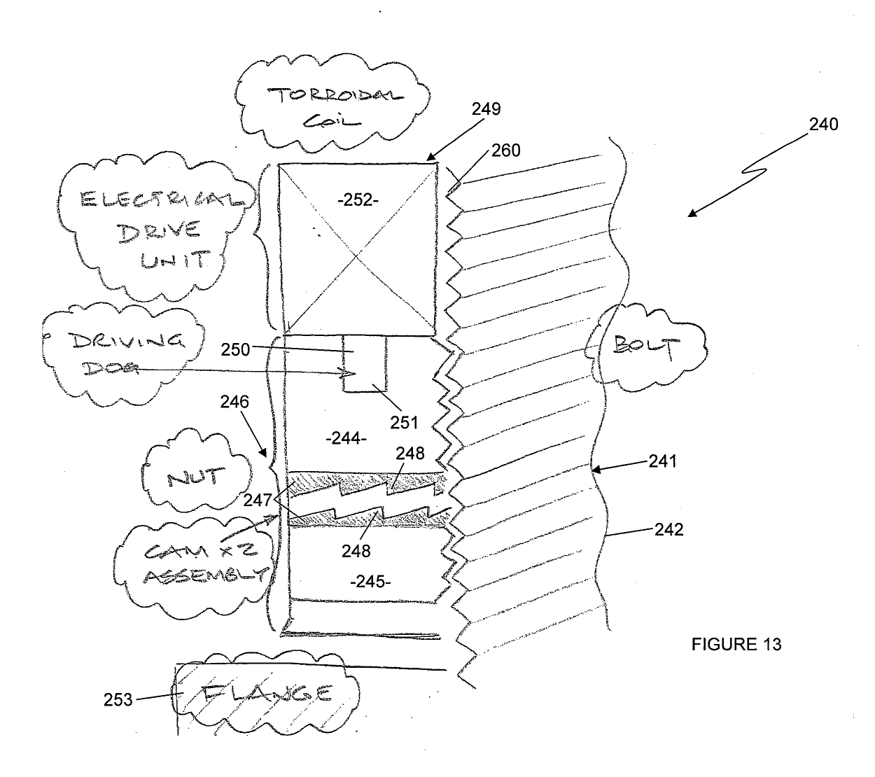

The nuts 244 and 245, as well as the washers 248, and the toroidal coil 252 are all depicted in cross-section in FIGS. 12 and 13.

A respective nut 244, nut 245, cam assembly 246, and drive 249 is located adjacent each end of the bolt 241, as can be seen in FIG. 12.

The bolt 241 is shown extending through a first flange 253, a second flange 254, and a metal to metal seal 255 that is located between the flanges 253, 254. The first flange 253 could for example belong to a first part of a pipeline system, and the second flange 254 could for example belong to a second part of the system. The first part and the second could each for example be a pipe or a flange.

The flanges 253, 254 and therefore the pipeline parts that they belong to can be secured together such that the seal 255 forms a seal between the flanges 253, 254. This can be accomplished by energising the toroidal coil 252 of each drive 249 by passing an electric current through it. Such a current can be passed through the coil 252 by connecting each end of the coil 252 to a DC or AC electrical power supply 256 with electrical conductors 257 so that the supply 256 is able to cause the current to flow through the conductors 257 and the coil 252. In the case where the pipeline system is a subsea pipeline system, the power supply 256 may be part of a ROV/AUV, for example.

Energising the coil 252 of each drive 249 causes the drives 249 to rotate the nuts 244 on the threaded bolt shaft 242 such that the nuts 244 along with the nuts 245 and the cam assemblies 246 are driven or moved along the shaft 242 towards the flanges 253, 254 and the seal 255.

The bolt 241 is heated to an optimum temperature by connecting the electrical heating rod 243 to an electrical power supply 258 with electrical conductors 259 so that the power supply 258 is able to supply an electric current to the rod 243 via the conductors 259. The current flows through the conductors 259 and the rod 243, and causes the rod 243 to heat. Heat from the rod 243 is transferred to the bolt 241 by conduction so that the bolt 241 is also heated. The secured together by tightening the nuts 229, a source of electricity is connected to the heating element of each bolt 227 so that an electrical current is able to flow from the source and through the heating element so that the element is heated. Heat from the heating elements is transferred to the bolts 227 so that they each expand to their elastic limit. Once the bolts 227 have expanded to their elastic limit, the nuts 229 are rotated relative to the bolts 227 until the flange 226 of the valve bonnet 222 is firmly secured to the rim 225 of the valve body 221. The electrical current that is supplied to the heating element is then removed or reduced.

The valve 220, including the valve body 221, flange 226, bolts 227 and nuts 229, can be pre-heated by the heating element of each bolt 227 prior to allowing hydrocarbons to flow through the valve 220. Pre-heating the valve 220 prevents it from being subjected to a sudden thermal contraction that may damage it.

By simply undoing the nuts 229 and removing the valve bonnet 222, the internals of the valve 220, including its valve and seat, can be changed out without having to disrupt and break the flange connections to the valve outlet 223 and inlet 224. This can potentially save time and huge amounts of intervention costs.

Referring to FIGS. 12 and 13, there is depicted a connection apparatus 240 that may be used for example to secure a first part of a pipeline system relative to a second part of the system.

Apparatus 240 includes a bolt 241 that has a threaded shaft 242. A cavity (not depicted) extends through the length of the bolt 241. The cavity receives a heating element in the form of an elongate electrical heating rod 243 that extends the length of the cavity and that protrudes from opposite ends of the bolt 241.

A nut 244 and a nut 245 are screwed on to the threaded shaft 242. A cam assembly 246 receives the shaft 242 and is positioned between the nuts 244, 245. Assembly 246 includes a pair of cams that are in the form of washers 247 that each include a plurality of wedges or teeth 248. The washers 247 are orientated such that the teeth 248 of each washer 247 face the teeth 248 of the other washer 247 and are able to engage with each other.

In addition, apparatus 240 includes an electrical drive 249 for rotating the optimum temperature to which the bolt 241 is heated corresponds to the temperature required to expand the bolt 241 to its elastic limit.

The nuts 244 and 245, and the cam assemblies 246 are driven along the shaft 242 by the drives 249 until the nuts 244 and 245 abut against the flanges 253, 254, and the bolt 241 has been heated to the optimum temperature. Once the nuts 244 and 245 abut against the flanges 253, 254, and the bolt 241 has been heated to the optimum temperature, the electrical power that is supplied to the rod 243 and the drives 249 is removed so that the drives 249 no longer rotate the nuts 244, and so that the bolt 241 is no longer heated by the rod 243.

The teeth 248 of the washers 247 provide the cam assembly 246 with a wedge locking action between the washers 247 that uses tension instead of friction between the washers 247. This wedge locking action allows the washers 247 to rotate with the nuts 244. The nuts 245 are coupled to the washers 247 such that they too are able to rotate with the nuts 244. The cam rise of the washers 247, which is a function of the height of the washer teeth 248, is larger than the pitch of a screw thread 260 that winds around the threaded shaft 242 of the bolt 241.

Additional teeth (not depicted) on the periphery of the washers 247 are able to aid in securing the bolt/nut arrangement relative to the flanges 253, 254. As the bolt 241 is heated by the heating rod 243, and the nuts 244, 245 are tightened by the drives 249, the additional teeth grip and seat into the cooler surfaces of the flanges 253, 254 and the nuts 244, 245.

As mentioned above, the cam assembly 246 is electrically driven into place and is locked by the action of the washers 247. This allows movement across the face of the cam assembly 246 only. Should the nuts 244 try to rotate relative to the bolt 241 so as to reduce any tension on the bolt 241, such rotation is restricted or resisted by the wedge locking action/wedge resistance effect of the cam assembly 246.

After the electrical power is removed from the electrical heating rod 243, the bolt 241 will cool and contract so that the force applied to the flanges 253, 254 by the nuts 244, 245 will increase. This cooling effect creates a very robust locking function for the connection between the flanges 253, 254. This can be especially important in the transmission of high pressure and high temperature gas through couplings, fittings, flanges, and pipelines due to either vibration and/or dynamic loading at critical unions.

The connection apparatus 240 is therefore able to function as a pre-tensioner arrangement that is able to pre-tension the bolt 241. This pre-tensioning is accomplished by heating the bolt 241 and by continuing to wind or screw the nuts 244, 245 along the bolt 241 while the bolt 241 is heated even after the nuts 244, 245 abut against the flanges 253, 254. The bolt 241 is maintained in tension even after it is cooled so that the nuts 244, 245 maintain a significant amount of pressure on the flanges 253, 254 to prevent or inhibit leakage between the seal 255 and the flanges 253, 254.

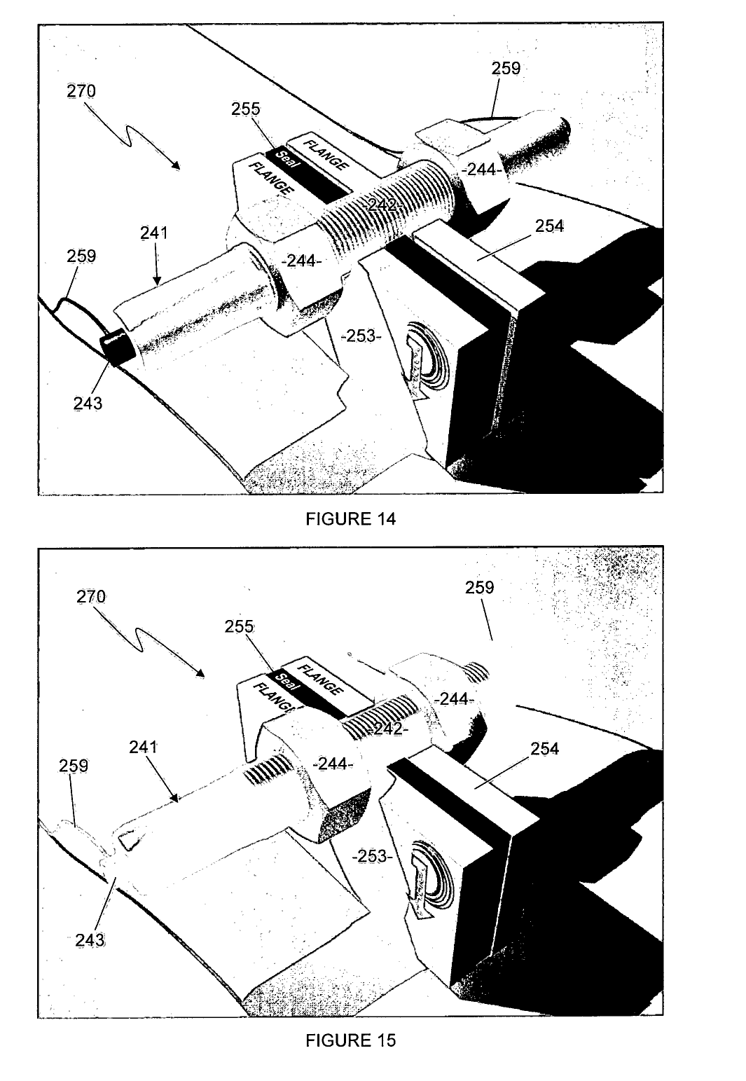

FIGS. 14 and 15 depict an alternative connection apparatus 270 that is similar to the apparatus 240. Therefore, like features of the apparatus 240, 270 have been referenced with like reference numbers.

For clarity, the nuts 245, cam assemblies 246, and the electrical drives 249 of the apparatus 270 are not depicted in FIGS. 14 and 15.

Both FIGS. 14 and 15 depict the bolt 241 of the connection apparatus 270 extending through a first flange 253, a second flange 254, and a seal 255. The flanges 253, 254 and the seal 255 are sectioned so that the portion of the bolt 241 that extends through them can be seen.

FIG. 14 depicts the connection apparatus 270 prior to the nuts 244 being screwed along the threaded shaft 242 towards the flanges 253, 254, and prior to the bolt 241 being heated by the electrical heating rod 243.

FIG. 15 depicts the connection apparatus 270 after the nuts 244 have been screwed along the threaded shaft 242 so that they abut against the flanges 253, 254, and after the bolt 241 has been heated to the optimum temperature by the heating rod 243.

Once the bolt 241 has been heated to the optimum heating temperature, the electrical power that causes the rod 243 to heat and the nuts 244 to be screwed along the shaft 242 towards the flanges 253, 254 is removed, and the bolt 241 etc. are allowed to cool.

When the bolt 241 is heated, it is placed in tension by tightening the nuts 244 with the drives 249. The nuts 244 also press or force the flanges 253, 254 towards each other and the seal 255. The bolt 241 contracts and remains in tension as it cools. The bolt 241, like the heatable bolts described previously, is therefore able to function as a thermal locking bolt.

The connection apparatus 240, 270 can be used either as is or in a modified form as part of a connection assembly, such as any of the connection assemblies that have been previously described above. For example, the connection apparatus 240, 270 can be used as part of the connection assembly 30 in place of the bolt 35, nuts 41 and 42, and the heating coil 37 of that assembly as originally described above.

It will be appreciated by those skilled in the art that variations and modifications to the invention described herein will be apparent without departing from the spirit and scope thereof. The variations and modifications as would be apparent to persons skilled in the art are deemed to fall within the broad scope and ambit of the invention as herein set forth.

Throughout the specification and claims, unless the context requires otherwise, the word “comprise” or variations such as “comprises” or “comprising”; will be understood to imply the inclusion of a stated integer or group of integers but not the exclusion of any other integer or group of integers.

Throughout the specification and claims, unless the context requires otherwise, the term “substantially” or “about” will be understood to not be limited to the value for the range qualified by the terms.

It will be clearly understood that, if a prior art publication is referred to herein, that reference does not constitute an admission that the publication forms part of the common general knowledge in the art in Australia or in any other country.

1. A bolt comprising
a threaded shaft, and
a heating element for heating the shaft.

2. The bolt of claim 1, wherein the shaft includes a cavity, and the heating element is inserted into the cavity such that the shaft is able to be heated by heating the heating element.

3. The bolt of claim 2, wherein the cavity and the heating element extend substantially along the full length of the shaft.

4. The bolt of of claim 1, wherein the heating element is selected from a group consisting of electrical heating element, an electrical heating coil, and an electrical heating rod.

5.-6. (canceled)

7. A method for securing a first part and a second part of a pipeline system together with the bolt of claim 1, the method comprising the steps of:
heating the bolt by heating the heating element of the bolt; and
securing the heated bolt to the first part and the second part.

8. The method of claim 7, wherein the shaft is heated to an optimum temperature.

9. The method of claim 8, wherein the optimum temperature is the temperature required to expand the bolt to its elastic limit.

10. The method of claim 7, wherein the securing step includes tightening a nut that is screwed on to the shaft of the bolt.

11. The method of claim 10, wherein the nut is tightened until the bolt has been heated to the optimum temperature.

12. The method of claim 8, wherein the step of heating the bolt is discontinued once the bolt has been heated to the optimum temperature

13. A connection assembly for securing a first part of a pipeline system to a second part of the system, comprising
a first portion,
a second portion, and
a bolt having a threaded shaft and a heating element for heating the shaft, the bolt extending between the first portion and the second portion.

14.-16. (canceled)

17. A method of securing a first part of a pipeline system to a second part of the system using the connection assembly of claim 13, the method comprising the steps of:
heating the bolt of the connection assembly by heating the heating element of the bolt; and
securing the first part to the second part with the connection assembly while each bolt of the connection assembly is heated.

18.-20. (canceled)

21. A clamp for securing a first part of a pipeline system to a second part of the system, comprising
a first jaw,
a second jaw hinged relative to the first jaw, and
bolt of claim 1, the bolt extending between the first jaw and the second jaw.

22. A connector for securing an end flange to a pipe, comprising
a first flange for the pipe,
a second flange for the end flange, and
bolt of claim 1, the bolt extending between the first flange and the second flange.

23. A connector for securing a first pipe to a second pipe, comprising
a first flange for the first pipe,
a second flange for the second pipe, and
bolt of claim 1, the bolt extending between the first flange and the second flange.

24. A valve comprising
a valve body including a rim surrounding an opening in the body,
a valve bonnet for covering the opening, the valve bonnet including a flange, and
bolt of claim 1, the bolt extending between the flange and the rim.

25. A pipeline system comprising
a first part,
a second part,
a connection assembly securing the first part to the second part, the connection assembly comprising a bolt having a threaded shaft and a heating element for heating the shaft, wherein the connection assembly is able to be heated by heating the heating element of bolt.

26.-28. (canceled)

29. A method for heating the connection assembly of the pipeline system of claim 25, the method comprising the steps of:
heating the connection assembly by heating the heating element of the bolt of the assembly; and
allowing heated matter to flow through the pipeline system such that heat from the heated matter is able to be transferred to the heated connection assembly.

30-32. (canceled)

33. A connection apparatus for securing a first part of a pipeline system to a second part of the system, the apparatus comprising
a bolt having a threaded shaft and a heating element for heating the shaft,
a nut for screwing on to the threaded shaft of the bolt,
a drive for rotating the nut on the threaded shaft
a second nut for screwing onto the threaded shaft, and
a pair of cams located between the nuts, wherein
the drive includes a dog for engaging with the nut so that the drive is able to rotate the nut on the threaded shaft, and
each cam is embodied as a washer that includes a plurality of teeth, with at least some of the teeth of each washer being engageable with each other.

34.-39. (canceled)

40. A method for securing a first part of a pipeline system to a second part of the system with the connection apparatus claim 33, the method comprising the steps of:
inserting the bolt of the connection apparatus through the first part and the second part of the pipeline system;
heating the bolt by heating the heating element of the bolt; and
tightening nut that is screwed the bolt.

41.-56. (canceled)
